(19) United States
(12) Patent Application Publication
(10) Pub. No.: US 2026/0237095 A1
(43) Pub. Date: Aug. 13, 2026

(54) METHOD OF DETERMINING A SPATIAL POSITION OF A PHOTOGRAPHIC IMAGE USING DYNAMIC ANALYSIS OF VIDEO

(71) Applicant: CUPIX, INC., Gyeonggi-do (KR)

(72) Inventors: Seock Hoon BAE, Seoul (KR); Jun Young PARK, Gyeonggi-do (KR); Jin Hwan CHOI, Seoul (KR); Kyu Seock LEE, Gyeonggi-do (KR)

(73) Assignee: CUPIX, INC., Gyeonggi-do (KR)

(21) Appl. No.: 19/640,403

(22) Filed: Apr. 6, 2026

Related U.S. Application Data
(63) Continuation of application No. PCT/KR2024/012039, filed on Aug. 13, 2024.

(30) Foreign Application Priority Data
Oct. 13, 2023 (KR) 10-2023-0136915

(51) Int. Cl. G06T 7/73

(52) U.S. Cl. CPC G06T 7/74; G06T 2207/10016; G06T 2207/30244

(57) ABSTRACT

The disclosure relates to a method of determining a spatial position of a photographic image using dynamic analysis of a video, and more particularly, to a method of calculating a spatial position of a photographic image by using a video captured by a video camera and a photographic image captured by a still camera during capture of the video. The method of determining a spatial position of a photographic image using dynamic analysis of a video according to the disclosure has an advantage in that a relative position of the photographic image may be effectively determined within a three-dimensional shape of a captured space identified using the video image frames.

### CROSS-REFERENCE TO RELATED APPLICATION

This is a continuation application of and claims the priority benefit of the International Patent Application of PCT application serial No. PCT/KR2024/012039, filed on August 13, 2024, which claims the priority benefit of Korea Patent Application No. 10-2023-0136915 filed on October 13, 2023. The entirety of each of the above mentioned patent applications is hereby incorporated by reference herein and made a part of this specification.

### BACKGROUND

### TECHNICAL FIELD

The disclosure relates to a method of determining a spatial position of a photographic image using dynamic analysis of a video, and more particularly, to a method of calculating a spatial position of a photographic image by using a video captured by a video camera and a photographic image captured by a still camera during capture of the video.

### Related Art

There exist various services provided using photographic images. Since photographic images are generally captured in a stationary state, they have relatively high sharpness. By using such photographic images having relatively high sharpness, it is possible to provide various services.

For example, by using photographic images and camera intrinsic parameters, such as a relative position between a projection center of a camera that captured the photographic images and a projection plane, and a size of the projection plane (a complementary metal-oxide semiconductor (CMOS) image sensor or a charge-coupled device (CCD) image sensor), positions, orientations, and projection centers of the respective photographic images may be calculated. In this manner, it is possible to use photographic images of the same object captured at different positions or angles, for various purposes, such as constructing a three-dimensional shape of the object, calculating a size or a distance of the object, or providing a 360 VR service.

In such a method of using photographic images, it is possible to provide higher-quality services as a larger number of photographs are captured at various angles and positions. However, capturing a large number of photographs requires relatively much time and effort.

Since a video is composed of a combination of image frames continuously captured over time, it has an advantage in that a large amount of image information may be obtained in a relatively short time. In particular, when a wide-angle camera or a 360 camera is used, a large amount of image information may be obtained in a relatively short time due to a wide angle of view. On the other hand, when a photographer moves while holding a video camera and capturing a video, a problem arises in that image frames of the captured video become blurred due to a decrease in sharpness depending on the movement speed and rotation speed. In the case of video data captured while the camera is moving, there is a high possibility that the sharpness of the image frames constituting the video is low. In images having low sharpness, contours of objects are not clear, and thus, shapes and outlines of objects displayed in the images cannot be accurately identified. In addition, when a captured image including text has low sharpness, it becomes difficult to recognize characters included in the image.

As described above, when image frames are extracted from data captured in the form of a video and used, various limitations arise in practical use due to the above-described problem of reduced sharpness.

For example, when a three-dimensional shape of a captured object is extracted using image frames of a video, the accuracy of the extracted three-dimensional shape may be reduced. In addition, when a distance between two points in space is calculated by using image frames of a video, the calculation result may also be inaccurate.

Further, when implementing a 360 VR image using image frames of a 360-degree video, if an area captured with low sharpness is displayed on a screen of a display device, there may occur a case in which it is difficult to identify detailed shapes of desired objects such as text, shapes, structures, or people. For example, when attempting to check progress of construction of a building through a video, there may occur a case in which it is difficult to verify whether main structures have been accurately constructed according to drawings, due to low sharpness of image frames.

Recently, technologies for generating and using visual documentation of a three-dimensional space by capturing a construction site or an interior space of a building using a video or the like have been increasingly widely used. Such technologies are used for purposes such as real estate brokerage and recording a construction status at a construction site.

However, due to the limitations of video images as described above, it may be difficult to effectively use such technologies for purposes such as visual documentation.

In order to compensate for such limitations of video, there is a case in which photographs captured with a high-resolution camera are used together. Although photographic images have high resolution and high sharpness, they have disadvantages in that an angle of view is relatively narrow and it is difficult to capture a large number of photographs within a short time. Accordingly, the number of photographs that may be obtained is limited, and thus, there is a problem in that it is difficult to grasp an overall shape of a three-dimensional space.

To address this, while capturing a video, portions important for visual documentation may be separately photographed using a high-resolution camera and used.

When a video and photographic images are used together in this manner, there is a problem in that it is difficult to identify a relationship between video image frames and the photographic images and to calculate a capture position of each photographic image or a spatial position of each photographic image in the captured space. When similarity between all image frames of the video and the photographic images is examined in order to determine a relationship between the video and the photographic images, there is a problem in that computational load and processing time increase dramatically.

Accordingly, there has been a need for a method capable of effectively determining a relationship between the video image frames and the photographic images while reducing computational load and processing time, thereby simultaneously taking the advantages of the video and the photographic images.

### SUMMARY

The disclosure has been devised to satisfy the necessity described above, and an object of the disclosure is to provide a method of determining a spatial position of a photographic image using dynamic analysis of a video, which is capable of effectively determining a relationship between a video and a photographic image by using a photographic image captured during capture of the video, and quickly finding a spatial position of the photographic image in a captured space.

To solve the above-described problems, the disclosure describes a method of determining a spatial position of a photographic image using dynamic analysis of a video using a video captured by a video camera and a photographic image captured by a still camera during capture of the video, the method including: (a) receiving, by a video reception module, the video captured by the video camera as a target video and receiving and storing camera intrinsic parameters of the video camera as video camera information; (b) receiving, by a photograph reception module, a target image in the form of a photographic image captured by the still camera and receiving and storing camera intrinsic parameters of the still camera as still camera information; (c) calculating, by a video position calculation module, relative positions of respective image frames of the target video with respect to a captured space by using the image frames of the target video and the video camera information; (d) selecting, by a low-speed image selection module, from among the image frames of the target video, image frames captured while the video camera was moving at a relatively low speed compared to other image frames as low-speed image frames; (e) comparing, by a similar image selection module, the target image with the low-speed image frames and selecting, from among the low-speed image frames, image frames having high similarity with respect to the target image as similar image frames; and (f) calculating, by a photograph position calculation module, a position of the target image by using video camera information of the similar image frames, positions of the similar image frames calculated by the video position calculation module, and still camera information of the target image.

The method of determining a spatial position of a photographic image using dynamic analysis of a video according to the disclosure has an advantage in that a large amount of image information may be quickly and effectively acquired from a captured video while separately acquiring a photographic image captured during capture of the video and effectively determining a relationship between the photographic image and video image frames.

In addition, the method of determining a spatial position of a photographic image using dynamic analysis of a video according to the disclosure has an advantage in that a relative position of the photographic image may be effectively determined in a three-dimensional shape of a captured space that may be identified using video image frames.

### BRIEF DESCRIPTION OF THE DRAWINGS

FIG. 1 is a block diagram of an apparatus for implementing an example of a method of determining a spatial position of a photographic image using dynamic analysis of a video according to the disclosure.

FIG. 2 is a flowchart illustrating an example of the method of determining a spatial position of a photographic image using dynamic analysis of a video according to the disclosure.

FIGS. 3 and 4 are diagrams for explaining a process of implementing the method of determining a spatial position of a photographic image using dynamic analysis of a video according to the disclosure.

### DETAILED DESCRIPTION

Hereinafter, a method of determining a spatial position of a photographic image using dynamic analysis of a video according to an embodiment of the disclosure will be described with reference to the accompanying drawings.

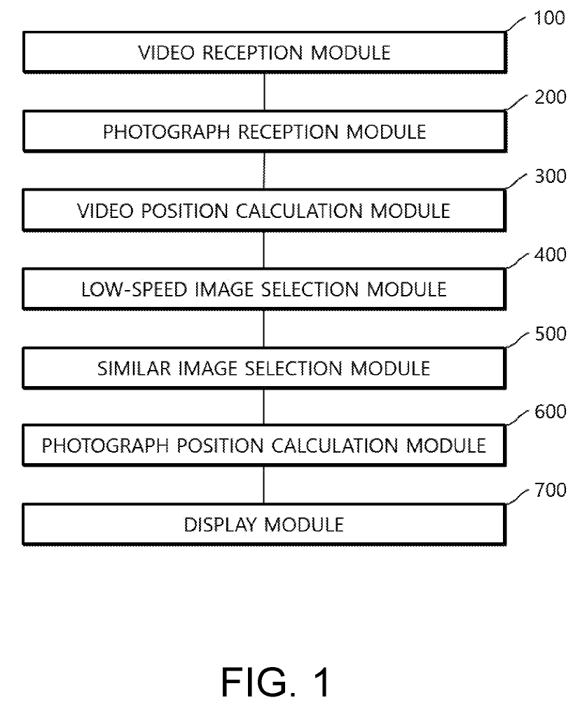

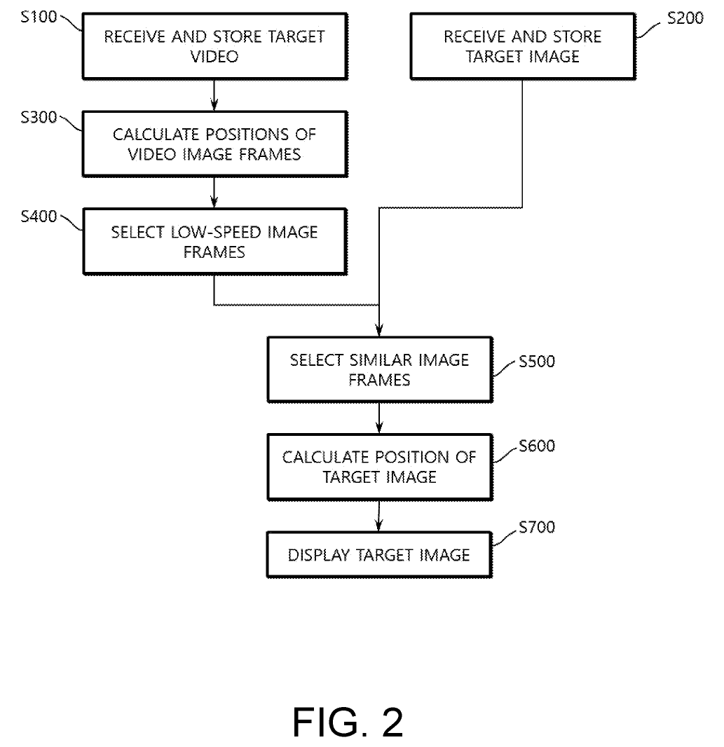

FIG. 1 is a block diagram of an apparatus for implementing an example of a method of determining a spatial position of a photographic image using dynamic analysis of a video according to the disclosure, and FIG. 2 is a flowchart illustrating an example of the method of determining a spatial position of a photographic image using dynamic analysis of a video according to the disclosure.

Referring to FIG. 1, an apparatus for implementing the method of determining a spatial position of a photographic image using dynamic analysis of a video according to the disclosure includes a video reception module 100, a photograph reception module 200, a video position calculation module 300, a low-speed image selection module 400, a similar image selection module 500, and a photograph position calculation module 600.

The video reception module 100 receives and stores a captured target video in a video format. The target video received by the video reception module 100 may be any type of video composed of image frames that may be rendered over time. In this embodiment, a video captured by a mobile device such as a smartphone or by a 360 camera is used as the target video. In some embodiments, the target video may be a two-dimensional video captured by a smartphone or camcorder, or may be a video captured and combined as a combination of hemispherical image frames for producing a 360 VR image, or may be a video captured as spherical image frames. Any video data captured using a camera lens and capable of being sequentially reproduced over time may be used as the target video. Hereinafter, a camera that captured the target video will be referred to as a video camera. The video reception module 100 receives camera intrinsic parameters of the video camera together with the target video and stores them as video camera information. Values such as a relative position between a projection center of a camera that captured a photograph or video and a projection plane, and a size of the projection plane (a complementary metal-oxide semiconductor (CMOS) image sensor or a charge-coupled device (CCD) image sensor) correspond to camera intrinsic parameters.

The video reception module 100 may additionally receive and store dynamic information regarding movement of the camera at a time of capturing the target video. The dynamic information is stored as a value that may be temporally mapped to the target video. Such dynamic information of the camera may be measured by various sensors such as an inertial measurement unit (IMU), an acceleration sensor, a geomagnetic sensor, an angular displacement sensor, and the like. In general, such dynamic information is measured by a dynamic sensor installed in a mobile device on which the camera is mounted. In this embodiment, a value measured over time by an IMU is used as the dynamic information.

The video reception module 100 receives and stores such dynamic information as a value corresponding to playback time of the target video.

The photograph reception module 200 receives and stores a target image in the form of a photographic image captured by a camera. Hereinafter, the camera that captured the target image will be referred to as a still camera. The still camera is a camera carried by a user together with the video camera and used while capturing the target video. While carrying the video camera and capturing the target video, the user may capture the target image using the still camera for a portion requiring text recognition or a clear image. Typically, the still camera is a device separate from the video camera, but in some embodiments, the video camera and the still camera may be installed in a single mobile device.

The photograph reception module 200 receives and stores camera intrinsic parameters of the still camera together with the target image as still camera information.

The video position calculation module 300 calculates relative positions of image frames of the target video in the captured space by using the image frames of the target video and the video camera information. By using a relationship between the video camera information and the video image frames, the video position calculation module 300 may calculate positions of the camera at which respective image frames were captured. The video position calculation module 300 may also calculate relative positions of the video image frames in a space in which the target video was captured. Positions of the video camera and the image frames may be calculated by using known methods such as structure-from-motion (SfM) or simultaneous localization and mapping (SLAM).

In some embodiments, the video position calculation module 300 may additionally use the dynamic information of the video camera to calculate the position of the camera. The video position calculation module 300 may calculate a position at which the target video was captured corresponding to time of the video using the dynamic information received by the video reception module 100. By additionally using a sensor measurement value such as that from an IMU, an acceleration sensor, or the like, the video position calculation module 300 may calculate a position at which the target video was captured, and may calculate a direction of each of the image frames of the target video when necessary. For example, since displacement variation may be calculated by integrating acceleration twice, a position at which a corresponding image frame was captured may be calculated by using such a calculated value. A direction of the camera may be calculated by using a measurement value from an angular velocity sensor such as a gyroscope. In some embodiments, other methods such as visual odometry or machine learning may also be used to calculate the positions and directions of the image frames of the target video.

The low-speed image selection module 400 selects, from among the image frames of the target video, image frames captured while moving at a relatively low speed compared to other image frames as low-speed image frames. The low-speed image selection module 400 may calculate speed, angular velocity, and magnitude of velocity of the video camera over time by using a value calculated by the video position calculation module 300. The low-speed image selection module 400 may select all or some image frames captured while the video camera moves at a relatively low speed and angular velocity as low-speed image frames. Various criteria and methods may be used for selecting such low-speed image frames.

When the speed and angular velocity of the video camera are less than or equal to a reference speed and a reference angular velocity, at least some of the image frames of the target video mapped to a corresponding time point may be selected as low-speed image frames by the low-speed image selection module 400. Values of the reference speed and the reference angular velocity may be predetermined as appropriate values.

Alternatively, when it is confirmed that the video camera remained in a reference region for a predetermined reference period, at least some image frames captured during the corresponding period may be selected as low-speed image frames by the low-speed image selection module 400. The reference period and range of the reference region may also be predetermined as appropriate values.

When the video reception module 100 also receives dynamic information, the low-speed image selection module 400 may additionally use the dynamic information. The low-speed image selection module 400 may identify a section in which the video camera moves at a relatively low speed using the dynamic information and may select image frames captured in the corresponding section as low-speed image frames.

Once low-speed image frames are selected in this manner, the similar image selection module 500 compares the target image with the low-speed image frames and selects at least some of the low-speed image frames having high similarity as similar image frames. In selecting similar image frames, the similar image selection module 500 may use an image retrieval algorithm such as Bag-of-Words (BoW) or VLAD.

The disclosure performs similarity determination with the target image only for the low-speed image frames, rather than comparing the target image with all image frames of the target video. Accordingly, the disclosure may dramatically reduce time and computational load required to select similar image frames from the target video.

The photograph position calculation module 600 calculates a position of the target image by using video camera information of the similar image frames, positions of the similar image frames calculated by the video position calculation module 300, and still camera information of the target image. The photograph position calculation module 600 may calculate the position of the target image from the similar image frames and the positions of the similar image frames by using a method such as a perspective-n-point (PnP) algorithm. The photograph position calculation module 600 may also calculate an average distance from the target image to a subject.

A display module 700 displays the target image on a display device. The display module 700 may display the target image on the display device in various manners. The display module 700 may display the target image by superimposing the target image on an image frame most similar to the target image when displaying the image frames of the target video. The display module 700 may also display the target image by placing the target image at a corresponding position and direction in a three-dimensional space implemented by calculation using the video image frames. The display module 700 may also display the target image by placing the target image at a position corresponding to the calculated average distance from the target image to the subject. Alternatively, the display module 700 may display the target image by registering the target image with a three-dimensional object implemented by the image frames of the target video such that their positions and directions are aligned.

Hereinafter, a process of implementing the method of determining a spatial position of a photographic image using dynamic analysis of a video according to the disclosure using the apparatus configured as described above will be described.

First, the video reception module 100 receives and stores a target video and video camera information (step (a); S100). As described above, various types of videos may be used as the target video depending on use and purpose. In some embodiments, the video reception module 100 may also receive and store dynamic information corresponding to capture of the target video.

The photograph reception module 200 also receives and stores a target image and still camera information (step (b); S200). The target image may be plural, but in this embodiment, a case in which the disclosure is implemented with respect to one target image will be described as an example. When a plurality of target images are provided, the process described in this embodiment may be repeated for each target image.

Subsequently, the video position calculation module 300 calculates relative positions of respective image frames of the target video in the captured space (step (c); S300). As described above, by using the video camera information and image frames, a position and direction of the video camera may be calculated by using a method such as SfM or SLAM, and in some embodiments, a three-dimensional shape of an object captured using two-dimensional image frames may also be reconstructed. In some embodiments, the dynamic information received and stored in step (a) may additionally be used to calculate the position and direction of the video camera.

Once the positions and directions of the image frames of the target video are calculated in this manner, the low-speed image selection module 400 selects low-speed image frames based thereon (step (d); S400). As described above, various criteria and methods may be used to select, from among the image frames of the target video, image frames captured while the video camera was moving at a relatively low speed as low-speed image frames.

Once low-speed image frames are selected in this manner, the similar image selection module 500 compares the low-speed image frames with the target image and selects image frames having high similarity with respect to the target image as similar image frames (step (e); S500). As described above, various known algorithms may be used for similarity determination. In addition, various criteria for selecting similar image frames may be determined. A reference similarity may be predetermined, and only image frames exceeding the reference similarity may be selected as similar image frames by the similar image selection module 500.

The photograph position calculation module 600 calculates a position and direction of the target image using the similar image frames, the video camera information, positions and directions of the similar image frames, the target image, and still camera information of the target image (step (f); S600). As described above, by using a method such as a PnP algorithm, the position and direction of the target image may be calculated by using the previously calculated information. Once the position and direction of the target image are obtained together with the positions of the image frames of the target video, the obtained information may be used for various purposes.

In particular, a video has the advantage that a large amount of image information may be obtained in a relatively short time, but has a limitation in accurately identifying detailed and precise information for a specific location due to a resolution limitation, and the disclosure effectively overcomes such a limitation. For a location requiring text recognition or accurate shape identification, a high-resolution photograph may be captured as the target image to compensate for disadvantages of the target video. In particular, by calculating the position and direction of the target image to correspond to the positions and directions of the image frames of the target video, it is possible to easily identify the target image while reviewing the image frames of the target video.

Further, as described above, similarity determination is performed only with respect to low-speed image frames rather than comparing the target image with all image frames of the target video, thereby making it possible to significantly reduce computational load. Accordingly, photographic images separately captured during video capture may be conveniently mapped to image frames of the video.

When using the method of determining a spatial position of a photographic image using dynamic analysis of a video according to the disclosure, a user may move relatively slowly or remain stationary while capturing a video of an area that may require later review, and may capture relatively high-resolution photographic images using a still camera for use together with the target video. The disclosure is characterized in that the target video and the target image are associated with each other based on such photographing movement of the user.

As an example of using the result of calculating the position and direction of the target image in step (f), the display module 700 may display the target image on a display device in association with the target video (step (g); S700).

The display module 700 may superimpose the target image on any one of the low-speed image frames corresponding to the position and direction of the target image, or may match the target image with a three-dimensional object implemented using the image frames of the target video and display the result on the display device.

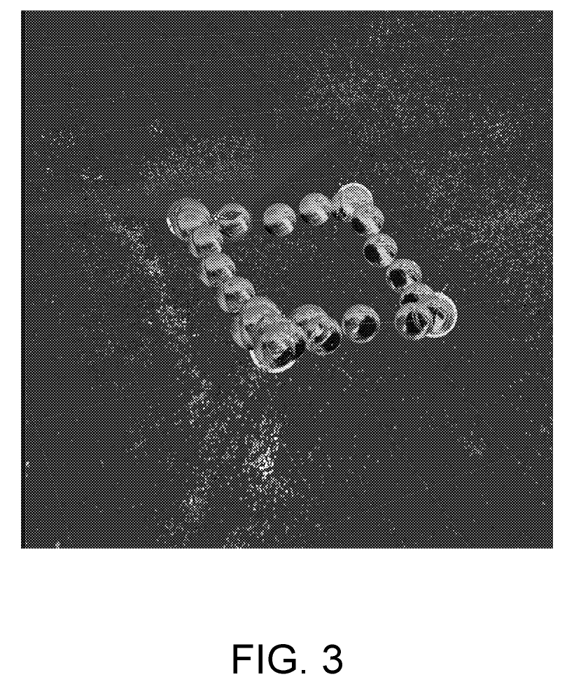

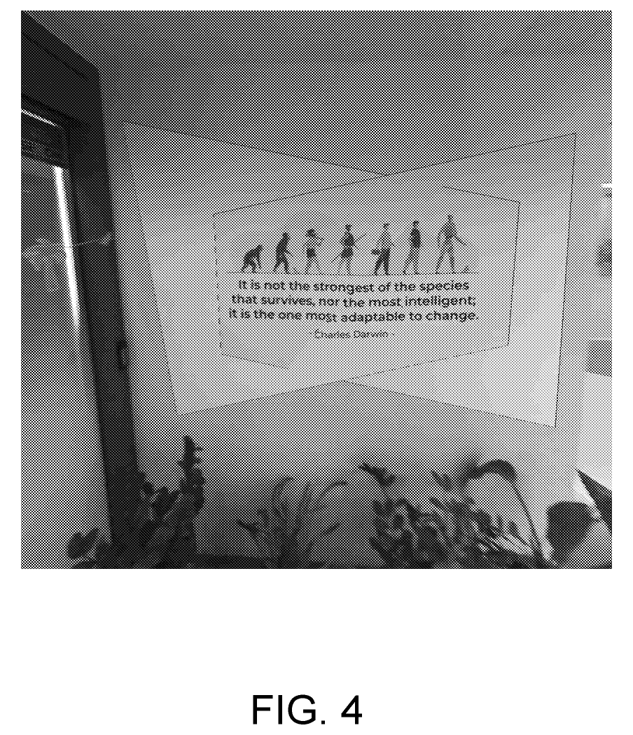

In some embodiments, a path within a building in which the target video was captured may be displayed on the display device, as illustrated in FIG. 3, and when a user selects a point on the path, the display module 700 may display a target image corresponding to the selected point, as illustrated in FIG. 4.

As described above, the method of providing various services using the target video and the target image according to the disclosure may be applied not only to general two-dimensional videos but also to all types of videos including 360-degree VR videos.

Although preferred examples of the disclosure have been described above, the scope of the disclosure is not limited to those described above.

For example, although the display module 700 has been described above as displaying the target image on the display device in step (g), the disclosure may be implemented without including step (g). The calculated position and direction of the target image may be output and stored as result values and may be variously used by other services. Even when the target image is displayed on the display device in step (g), various display methods other than those described above may be used.

Further, although dynamic information of the video camera has been described above as being received and stored in step (a) and used in step (c), it is also possible not to use dynamic information. That is, the disclosure may be implemented using only the video camera information and the video without receiving or using dynamic information.

In addition, although the video camera and the still camera have been described as separate devices, in some embodiments, the video camera and the still camera may be installed in a single mobile device and used together. In some embodiments, the video camera and the still camera may be the same camera. In this case, the camera may operate to momentarily capture a high-resolution photographic image while capturing a video.

What is claimed is:

1. A method of determining a spatial position of a photographic image by dynamic analysis of a video using a video captured by a video camera and a photographic image captured by a still camera during capture of the video, the method comprising:
(a) receiving, by a video reception module, the video captured by the video camera as a target video and receiving and storing camera intrinsic parameters of the video camera as video camera information;
(b) receiving, by a photograph reception module, a target image in the form of a photographic image captured by the still camera and receiving and storing camera intrinsic parameters of the still camera as still camera information;
(c) calculating, by a video position calculation module, relative positions of respective image frames of the target video with respect to a captured space by using the image frames of the target video and the video camera information;
(d) selecting, by a low-speed image selection module, from among the image frames of the target video, image frames captured while the video camera was moving at a relatively low speed compared to other image frames as low-speed image frames;
(e) comparing, by a similar image selection module, the target image with the low-speed image frames and selecting image frames having a high similarity with respect to the target image from among the low-speed image frames as similar image frames; and
(f) calculating, by a photograph position calculation module, a position of the target image by using video camera information of the similar image frames, positions of the similar image frames calculated by the video position calculation module, and still camera information of the target image.

2. The method of claim 1, wherein
step (c) is performed by the video position calculation module using one of structure-from-motion (SfM) and simultaneous localization and mapping (SLAM).

3. The method of claim 1, wherein
step (f) comprises calculating, by the photograph position calculation module, the position of the target image by using a perspective-n-point (PnP) algorithm.

4. The method of claim 1, wherein
step (a) further comprises receiving and storing, by the video reception module, a measurement value of a dynamic sensor of the video camera corresponding to a playback time of the target video as dynamic information.

5. The method of claim 4, wherein
step (a) comprises receiving a measurement value of an inertial measurement unit (IMU) as the measurement value of the dynamic sensor.

6. The method of claim 4, wherein
step (c) comprises calculating, by the video position calculation module, positions of the image frames of the target video by additionally using the dynamic information.

7. The method of claim 4, wherein
step (d) comprises selecting, by the low-speed image selection module, the low-speed image frames by using the dynamic information.

8. The method of claim 4, wherein
step (d) comprises selecting, by the low-speed image selection module, at least some of the image frames of the target video corresponding to a playback time when a measurement value of the dynamic sensor is less than or equal to a reference speed and a reference angular velocity as low-speed image frames.

9. The method of claim 1, wherein
step (d) comprises, when the video camera moves at a speed lower than a preset reference speed, selecting, by the low-speed image selection module, at least some of the corresponding image frames as low-speed image frames.

10. The method of claim 1, wherein
step (d) comprises, when the video camera is confirmed to have remained within a reference region for a preset reference time, selecting, by the low-speed image selection module, at least some of image frames captured during the corresponding time period as low-speed image frames.

11. The method of claim 1, further comprising:
(g) displaying, by a display module, the target image on a display device.

12. The method of claim 11, wherein
step (g) comprises superimposing, by the display module, the target image on one of the low-speed image frames by using the position of the target image calculated in step (f).

13. The method of claim 11, wherein
step (g) comprises matching, by the display module, the target image with a three-dimensional object implemented using the image frames of the target video, by using the position of the target image calculated in step (f), and displaying the matching result.
